(19) United States
(12) Patent Application Publication
(10) Pub. No.: US 2026/0145154 A1
(43) Pub. Date: May 28, 2026

(54) A TUBULAR PLASMA REACTOR FOR THE TREATMENT OF CONTAMINANTED FOAM

(71) Applicant: Clarkson University, Potsdam, NY (US)

(72) Inventors: Osakpolo F. Isowamwen, Potsdam, NY (US); Thomas M. Holsen, Potsdam, NY (US); Selma Medovic-Thagard, Potsdam, NY (US)

(73) Assignee: Clarkson University, Potsdam, NY (US)

(21) Appl. No.: 19/121,053

(22) PCT Filed: Oct. 13, 2023
(86) PCT No.: PCT/US2023/076869

§ 371 Date: Apr. 14, 2025

Related U.S. Application Data
(60) Provisional application No. 63/415,843, filed on Oct. 13, 2022.

(51) Int. Cl. B01J 19/08

(52) U.S. Cl. CPC B01J 19/088; B01J 2219/00099; B01J 2219/0809; B01J 2219/0869; B01J 2219/0871; B01J 2219/0884; B01J 2219/0896

(57) ABSTRACT

The generation of electrical discharge plasma in foam containing adsorbed contaminants in the gas phase. In the conventional gas discharge reactors, the plasma electrode configuration features one of the electrodes in the liquid phase and the other in the gas phase such that plasma propagates on the surface of the liquid. In this system, both electrodes are covered by the foam. The surface of the bubbles in the foam serves as adsorption sites for the contaminant which decreases bulk liquid mass transport and increases the contact area between the plasma species and the contaminants.

### CROSS-REFERENCE TO RELATED APPLICATION

The present application relates and claims priority to U.S. Provisional Patent Application No. 63/415,843 , filed Oct. 13, 2022, the entirety of which is hereby incorporated by reference.

### FIELD OF THE INVENTION

The present disclosure is directed generally to a system that treats foam-containing organic contaminants using a plasma-based process.

### BACKGROUND

The ubiquitous presence of organic contaminants in wastewater is a global issue that has threatened public health and safety. A variety of physical and biological treatment methods have been employed for the removal of these organic pollutants from water, such as adsorption, ultrafiltration, and advanced oxidation and reduction processes, etc. However, some of these processes are either energy-intensive, require expensive handling, or generate toxic byproducts.

Gas-phase electrical discharge plasma is a novel treatment method that has proven to be very effective in degrading surfactants and non-surfactants in water. It employs diffusers to generate bubbles in the bulk liquid, which aid the transport of surfactants to the gas-liquid interface. For non-surfactants that are unable to adsorb easily to the bubble surface, a cationic surfactant is added, to which these compounds bind electrostatically on the bubble surface and are transported to the plasma-liquid interface. Although the plasma-assisted process has been demonstrated to degrade non-surfactants with relatively high efficiency, it requires long treatment times due to the re-entrainment of the non-surfactants into the bulk liquid after the rupture of the bubbles by the plasma.

Accordingly, there is a need in the art for a system that treats foam-containing organic contaminants using a plasma-based process.

### SUMMARY

The present disclosure is directed to a system that treats foam-containing organic contaminants using a plasma-based process.

A plasma tubular reactor enables the generation of plasma within the accumulated foam in the gas phase. The discharge and grounded electrodes are enveloped by the foam in the gas phase such that plasma contacts and possibly ruptures the formed bubbles. This allows fast solvation of electrons and ions on the bubble surface and thus fast contaminant removal.

According to an aspect is an electrical discharge plasma reactor system for treating foam containing adsorbed contaminants, the reactor system comprising a reactor chamber configured to contain liquid, gas and foam therein, and a means for cooling the reactor chamber; a discharge electrode disposed within the reactor chamber; a grounded electrode positioned adjacent the discharge electrode; a diffuser adapted to generate bubbles that produce foam in the gas phase; and a power supply connected to at least one of the discharge electrodes and the grounded electrode, the power supply configured to induce the discharge electrode and the grounded electrode to generate plasma within the foam.

According to an embodiment, the diffuser is positioned at the bottom of the reactor chamber.

According to an embodiment, the diffuser comprises pores that are one of nano, micro, or macro sized, wherein the size of the bubbles generated ranges is determined by the bulk liquid concentration of the compounds.

According to an embodiment, the means for cooling the reactor chamber comprises an outer cylinder concentrically positioned around the reactor chamber.

According to an embodiment, the discharge electrode configuration comprises of various combinations of single or multiple points, rings, rods, or plates disposed within a gas.

According to an aspect is a method for treating foam containing adsorbed contaminants using an electrical discharge plasma reactor system, the method comprising the steps of containing liquid, gas and foam in a reactor chamber; providing a colling jacket around the reactor chamber; using a diffuser to generate bubbles that produce foam in the gas phase at the bottom of the reactor chamber; and establishing a sufficiently high electric potential difference between two electrodes to generate an electrical discharge plasma in the foam accumulated in the gas phase.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a front view of a point-ring tubular plasma reactor, in accordance with an embodiment.

### DETAILED DESCRIPTION OF EMBODIMENTS

The present disclosure describes alternative methods for generating electrical discharge plasma for the treatment of foam-containing absorbed contaminants.

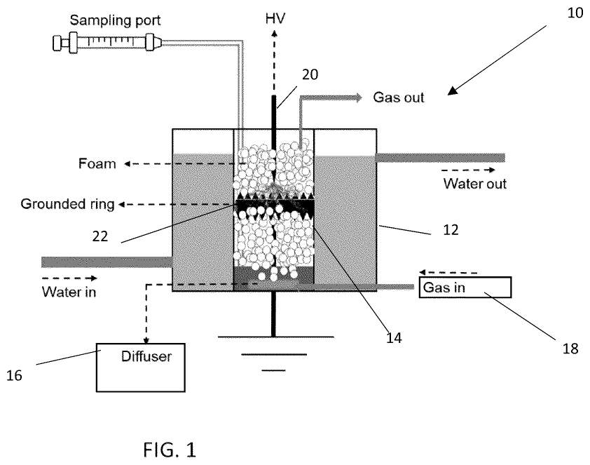

Referring to FIG. 1, in one embodiment, is a plasma reactor apparatus 10 made of two concentric cylinders; the outer cylinder 12 that serves as a cooling jacket and the inner cylinder 14 that serves as the reactor chamber for the foam treatment; in some embodiments the cooling jacket 12 may be omitted. A diffuser 16 connected to a gas (external gas cylinder) 18 located at the bottom of the reactor 10 is used to generate bubbles in the liquid that ultimately results in foam accumulation above the liquid (or bubbles may be formed in another reactor using gas diffusers or other means and the foam transported into the plasma reactor.) Two electrodes 20, 22 are placed above the liquid in a (multi) point-ring, (multi) point-point, ring-ring and other configurations in which voltage is applied to one of the electrodes to generate electrical discharge plasma. The other electrode is either grounded or connected to lower voltage to establish a sufficiently high electric potential difference. The foam accumulated in the gas phase completely covers the two electrodes 20, 22 which upon applied voltage generate a spark-like discharge (plasma) within the foam.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An electrical discharge plasma reactor system for treating foam containing adsorbed contaminants, the reactor system comprising:
a. a reactor chamber configured to contain liquid, gas and foam therein, and a means for cooling the reactor chamber;
b. a discharge electrode disposed within the reactor chamber;
c. a grounded electrode positioned adjacent the discharge electrode;
d. a diffuser adapted to generate bubbles that produce foam in the gas phase; and
e. a power supply connected to at least one of the discharge electrodes and the grounded electrode, the power supply configured to induce the discharge electrode and the grounded electrode to generate plasma within the foam.

2. The electrical discharge plasma reactor system according to claim 1, wherein the diffuser is positioned at the bottom of the reactor chamber.

3. The electrical discharge plasma reactor system according to claim 1, wherein the diffuser comprises pores that are one of nano, micro, or macro sized, wherein the size of the bubbles generated ranges is determined by the bulk liquid concentration of the compounds.

4. The electrical discharge plasma reactor system according to claim 1, wherein the means for cooling the reactor chamber comprises an outer cylinder concentrically positioned around the reactor chamber.

5. The electrical discharge plasma reactor system according to claim 1, wherein the discharge electrode configuration comprises of various combinations of single or multiple points, rings, rods, or plates disposed within a gas.

6. A method for treating foam containing adsorbed contaminants using an electrical discharge plasma reactor system, the method comprising the steps of:
a. containing liquid, gas and foam in a reactor chamber;
b. providing a colling jacket around the reactor chamber;
c. using a diffuser to generate bubbles that produce foam in the gas phase at the bottom of the reactor chamber; and
d. establishing a sufficiently high electric potential difference between two electrodes to generate an electrical discharge plasma in the foam accumulated in the gas phase.
